(19) United States
(12) Patent Application Publication
(10) Pub. No.: US 2016/0018911 A1
(43) Pub. Date: Jan. 21, 2016

(54) TOUCH PEN

(71) Applicant: Primax Electronics Ltd., Neihu (TW)

(72) Inventors: SHIH-CHIEH LAN, Neihu (TW); YING-CHE TSENG, Neihu (TW); A-MING CHANG, Neihu (TW)

(21) Appl. No.: 14/483,480

(22) Filed: Sep. 11, 2014

(30) Foreign Application Priority Data
Jul. 17, 2014 (CN) 201410340632.2

(51) Int. Cl. G06F 3/0354; G06F 3/044

(52) U.S. Cl. CPC G06F 3/03545; G06F 3/044

(57) ABSTRACT

A touch pen controls a capacitive touch screen and an electronic device. The electronic device includes a first wireless transmission module. The touch pen includes a pen tip, a second wireless transmission module, a G-sensor, and a pressure sensor. The pen tip is interacted with the capacitive touch screen. The second wireless transmission module is in communication with the first wireless transmission module. According to an angle change of the touch pen sensed by the G-sensor, a first control signal is transmitted from the second wireless transmission module to the first wireless transmission module to control the electronic device. According to a pressure exerted on the pen tip and sensed by the pressure sensor, a second control signal is transmitted from the second wireless transmission module to the first wireless transmission module or the capacitive touch screen to control the first wireless transmission module or the capacitive touch screen.

### FIELD OF THE INVENTION

The present invention relates to a touch pen, and more particularly to a touch pen for controlling a capacitive touch screen and an electronic device.

### BACKGROUND OF THE INVENTION

Nowadays, the commercially available touch screens are classified into several types, including a resistive touch screen, an acoustic wave touch screen, an infrared touch screen and a capacitive touch screen. When an external force is exerted on the resistive touch screen, a voltage is generated and a command is recognized according to the voltage. Moreover, acoustic waves or infrared rays pass over the surface of the acoustic wave touch screen or the infrared touch screen. By touching the surface of the acoustic wave touch screen or the infrared touch screen, the travelling path of the acoustic wave or the infrared ray is blocked and thus the corresponding command is recognized. When the human body is contacted with the capacitive touch screen, the capacitance value of the touch point of the capacitive touch screen is subjected to a change. According to the change of the capacitance value, the position of the touch position is recognized. In views of the touch accuracy and the fabricating cost, the capacitive touch screen is widely adopted.

For complying with the utilized function of the capacitive touch screen, a capacitive touch pen is introduced into the market. Hereinafter, the structure of a conventional touch pen will be illustrated with reference to FIG. 1. FIG. 1 is a schematic cross-sectional view illustrating a conventional touch pen. A conductive rubber tip 11 of the conventional touch pen 1 is used as a contact terminal. The conductive rubber tip 11 is sheathed around a fixing post 13, which is contacted with a metallic pen tube 12. Consequently, the conductive rubber tip 11 and the metallic pen tube 12 are combined together. When the conductive rubber tip 11 touches the capacitive touch screen, the electric energy of the human body is transmitted to the conductive rubber tip 11 through the metallic pen tube 12 and the fixing post 13. Consequently, the capacitance value of the touch point between the capacitive touch screen and the conductive rubber tip 11 is changed. According to the change of the capacitance value, a position of the touch point can be accurately judged by the capacitive touch screen.

However, the conventional capacitive touch pen is only able to be interacted with the capacitive touch screen in order for implementing the writing, drawing or selecting functions. Nowadays, as the capacitive touch pen is gradually popular, it is important to increase the functions of the capacitive touch pen. That is, the capacitive touch pen is applied to not only the capacitive touch screen but also other electronic devices.

### SUMMARY OF THE INVENTION

An object of the present invention provides a multi-function touch pen for controlling a capacitive touch screen and an electronic device.

In accordance with an aspect of the present invention, there is provided a touch pen for controlling a capacitive touch screen and an electronic device. The electronic device includes a first wireless transmission module. The touch pen includes a pen tip, a second wireless transmission module, a G-sensor, and a pressure sensor. The pen tip is interacted with the capacitive touch screen. The second wireless transmission module is in communication with the first wireless transmission module. The G-sensor senses an angle change of the touch pen. The pressure sensor senses a pressure that is exerted on the pen tip. According to the angle change of the touch pen sensed by the G-sensor, a corresponding first control signal is transmitted from the second wireless transmission module to the first wireless transmission module so as to control the electronic device. According to the pressure exerted on the pen tip and sensed by the pressure sensor, a corresponding second control signal is transmitted from the second wireless transmission module to the first wireless transmission module or the capacitive touch screen so as to control the first wireless transmission module or the capacitive touch screen.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating a conventional touch pen;

FIG. 2 is a schematic cross-sectional view illustrating a touch pen according to an embodiment of the present invention;

FIG. 3 is a schematic functional block diagram illustrating the relationship between and electronic device and the touch pen according to the embodiment of the present invention;

FIG. 4 schematically illustrates an application example of the touch pen in the first remote control mode according to the embodiment of the present invention;

FIG. 5 schematically illustrates the relationships between some symbol gestures and the corresponding tasks for the application example of FIG. 4 in the first remote control mode;

FIG. 6 schematically illustrates the relationships between some symbol gestures and the corresponding tasks for the touch pen in a second remote control mode;

FIG. 7 schematically illustrates the relationships between some symbol gestures and the corresponding tasks for the touch pen in a third remote control mode;

FIG. 8 schematically illustrates an application example of the touch pen in a fourth remote control mode according to the embodiment of the present invention;

FIG. 9 schematically illustrates the relationships between some symbol gestures and the corresponding tasks for the application example of FIG. 8 in the fourth remote control mode;

FIG. 10 schematically illustrates the use of the touch pen to control the electronic device by issuing a second control signal; and

FIG. 11 schematically illustrates the use of the touch pen to control the capacitive touch screen by issuing a second control signal.

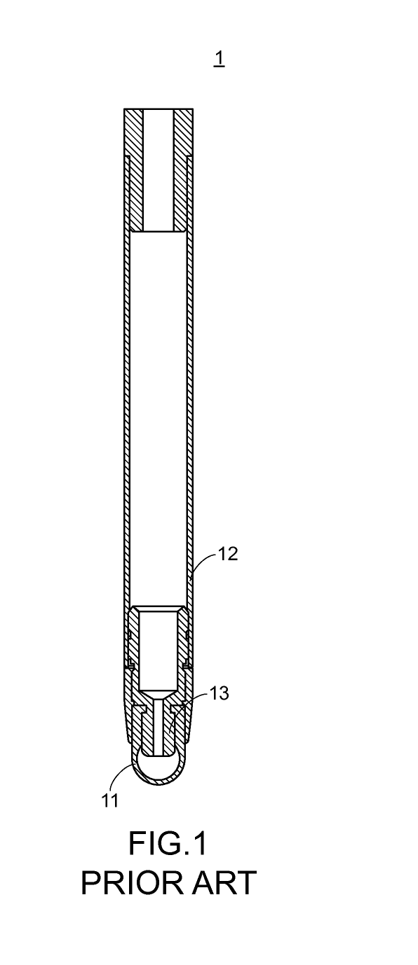

### DETAILED DESCRIPTION OF THE PREFERRED EMBODIMENT

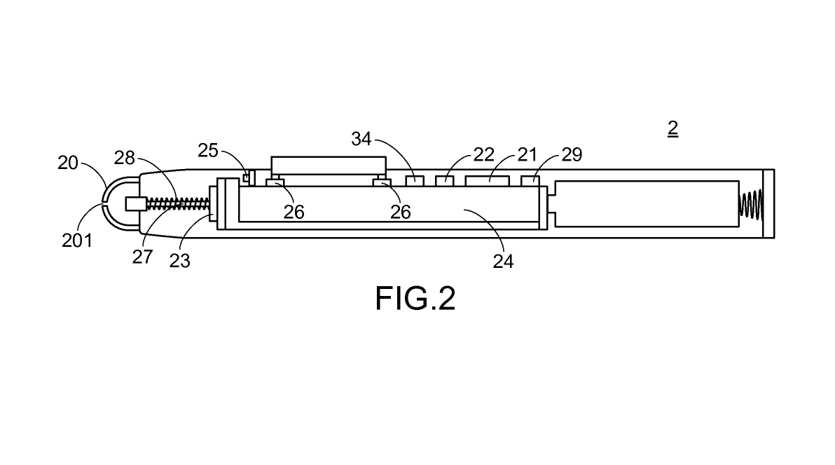

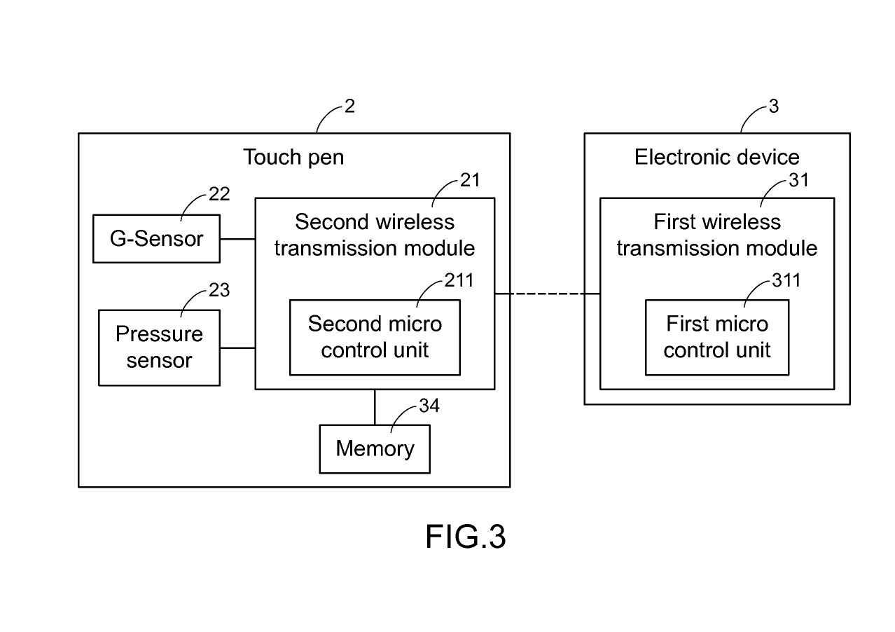

Hereinafter, a touch pen 2 according to an embodiment of the present invention will be illustrated with reference to FIGS. 2 and 3. FIG. 2 is a schematic cross-sectional view illustrating a touch pen according to an embodiment of the present invention. FIG. 3 is a schematic functional block diagram illustrating the relationship between and electronic device and the touch pen according to the embodiment of the present invention.

The components of the touch pen 2 will be illustrated as follows. In this embodiment, the touch pen 2 comprises a pen tip 20, a second wireless transmission module 21, a G-Sensor 22, a pressure sensor 23, a circuit board 24, a laser source 25, two push buttons 26, an indication light source 29, and a memory 34. The second wireless transmission module 21, the G-Sensor 22, the pressure sensor 23, the laser source 25, the two push buttons 26, the indication light source 29 and the memory 34 are disposed on the circuit board 24. The second wireless transmission module 21 comprises a second micro control unit (MCU) 211. The laser source 25 faces the pen tip 20. The pen tip 20 comprises a perforation 201. A light beam emitted by the laser source 25 may pass through the perforation 201 of the pen tip 20. In this embodiment, the touch pen 2 is a passive touch pen, and the pen tip 20 is made of a conductive rubbery material. The principles of operating a capacitive touch screen through the interaction between the pen tip 20 and the capacitive touch screen are well known to those skilled in the art, and are not redundantly described herein.

It is noted that the touch pen 2 is not restricted to the passive touch pen. For example, in another embodiment, the touch pen 2 is an active touch pen. In case that the touch pen 2 is the active touch pen, the pen tip 20 is made of a metallic material or a conductive plastic material, and the pen tip 20 is cone-shaped.

In accordance with a feature of the present invention, the touch pen 2 may operate the electronic device 3 as shown in FIG. 3 by means of the second wireless transmission module 21, the G-Sensor 22 and the pressure sensor 23. As shown in FIG. 3, the electronic device 3 comprises a first wireless transmission module 31. The first wireless transmission module 31 comprises a first micro control unit (MCU) 311. The first wireless transmission module 31 is in communication with the second wireless transmission module 21. The first wireless transmission module 31 may receive a first control signal from the G-Sensor 22 and a second control signal from the pressure sensor 23.

After the two push buttons 26 are simultaneously pressed down for a predetermined time period and then one of the two push buttons 26 is pressed down, a different remote control mode may be selected. If the other push button 26 is pressed down, the touch pen 2 is in the corresponding remote control mode. When the touch pen 2 is in any remote control mode and the touch pen 2 is paired with the electronic device 3 corresponding to the remote control mode, the user may use the touch pen 2 to implement a character input function and a gesture symbol input function so as to operate the electronic device 3.

When the touch pen 2 is in any remote control mode, if the two push buttons 26 are simultaneously pressed down for the predetermined time period, the touch pen 2 is returned to a touch mode. When the touch pen 2 is in the touch mode, the G-Sensor 22 is disabled. Under this circumstance, the capacitive touch screen is operated by the user through the interaction between the pen tip 20 and the capacitive touch screen, and the character input function and the gesture symbol input function cannot be implemented.

Moreover, the indication light source 29 may emit different color light beams according to each remote control mode or the touch mode of the touch pen 2. According to the color light beam, the operating mode of the touch pen 2 can be realized by the user and will not confuse the user.

Hereinafter, the operations of the touch pen 2 in different remote control mode will be illustrated with reference to various application examples. In the following application examples, the process of pairing the first wireless transmission module 31 of the electronic device 3 with the second wireless transmission module 21 of the touch pen 2 has been completed. Moreover, the following application examples are presented herein for purpose of illustration and description only. It is noted that the number of the remote control modes and the type of the corresponding electronic device 3 may be varied according to the practical requirements.

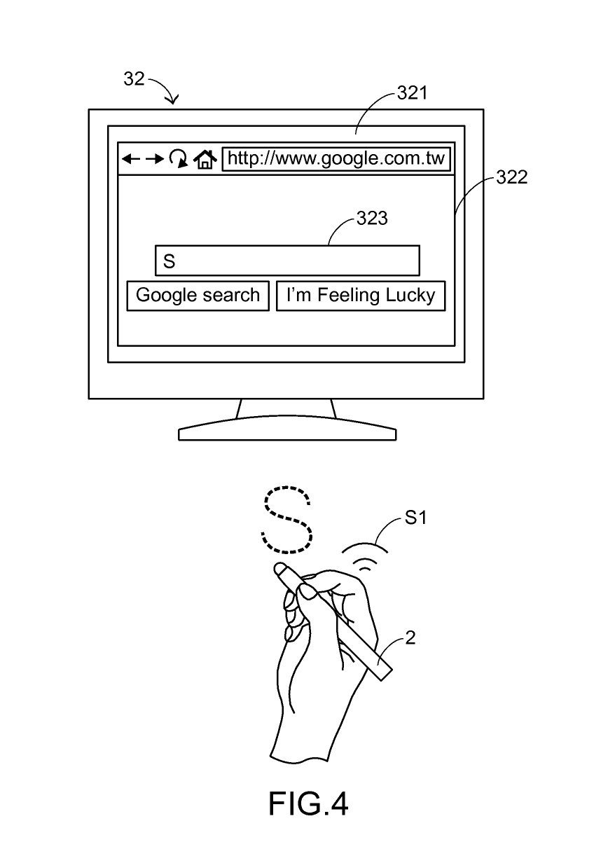

Hereinafter, an application example of the touch pen in the first remote control mode will be illustrated with reference to FIGS. 2, 3 and 4. FIG. 4 schematically illustrates an application example of the touch pen in the first remote control mode according to the embodiment of the present invention. In this embodiment, the electronic device 3 is an intelligent appliance. For example, the electronic device 3 is a television 32 with a networking function. After the touch pen 2 is operated in the first remote control mode and paired with the television 32, the user may use the touch pen 2 to input characters into the television 32. This action will be illustrated as follows.

In this application example, a browser window 322 is shown on a display screen 321 of the television 32. Moreover, a search engine interface is shown on the browser window 322. For inputting a character (e.g. an English letter “S”) into a search bar 323 of the search engine interface, the touch pen 2 can be directly used to write the English letter “S” (see the dashed line) in the air (e.g. without any writing carrier). More especially, the G-Sensor 22 can sense the angle change of the touch pen 2. When the touch pen 2 is used to write the English letter “S” in the air, the angle change of the touch pen 2 sensed by the G-Sensor 22 is transmitted to the second wireless transmission module 21. After the angle change of the touch pen 2 is analyzed by the second micro control unit 211 of the second wireless transmission module 21, the angle change of the touch pen 2 is converted into an instruction code corresponding to the English letter “S”. Then, a first control signal S1 containing the instruction code corresponding to the English letter “S” is transmitted from the second wireless transmission module 21 to the first wireless transmission module 31 (see FIG. 3) of the television 32.

After the first control signal S1 is received by the first wireless transmission module 31, the first micro control unit 311 (see FIG. 3) judges that the first control signal S1 contains the instruction code corresponding to the English letter “S”. Moreover, under control of the first micro control unit 311, the English letter “S” is shown in the search bar 323 of the television 32. Consequently, the character input function is achieved. In other words, by means of the G-Sensor 22, the touch pen 2 can be used to write various characters in the air without the need of contacting the touch pen 2 with the television 32. The examples of the characters include but are not limited to the English letters “A”˜“Z” and the numbers 0˜9.

Moreover, while the touch pen 2 is used to write characters in the air, the laser source 25 may be enabled to project a light beam onto the display screen 321. According to the light beam, the user is able to confirm the written characters, and thus the operating feel is enhanced.

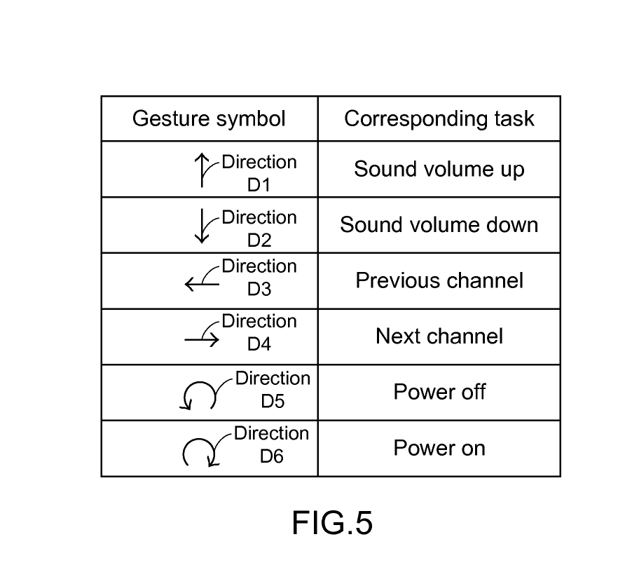

FIG. 5 schematically illustrates the relationships between some symbol gestures and the corresponding tasks for the application example of FIG. 4 in the first remote control mode. Please refer to FIGS. 2, 3 and 5. In addition to the character input function, the user may move the touch pen 2 along a specified direction so as to implement a corresponding task. For example, if the user creates a gesture symbol by moving the touch pen 2 in the air along a leftward direction (i.e. the direction D3), the G-Sensor 22 may sense that the angle change of the touch pen 2 is a leftward shift. In addition, the angle change of the touch pen 2 sensed by the G-Sensor 22 is transmitted to the second wireless transmission module 21. After the angle change of the touch pen 2 is analyzed by the second micro control unit 211 of the second wireless transmission module 21, the angle change of the touch pen 2 is converted into an instruction code corresponding to the leftward-movement gesture symbol. Then, a first control signal containing the instruction code corresponding to the leftward-movement gesture symbol is transmitted from the second wireless transmission module 21 to the first wireless transmission module 31 (see FIG. 3) of the television 32.

After the first control signal from the second wireless transmission module 21 is received by the first wireless transmission module 31, the first micro control unit 311 (see FIG. 3) judges that the first control signal contains the instruction code corresponding to the leftward-movement gesture symbol. Moreover, under control of the first micro control unit 311, the displayed channel of the television 32 is switched to the previous channel. Consequently, the corresponding task is implemented.

Similarly, in the first remote control mode, if the user creates a gesture symbol by moving the touch pen 2 in the air along a rightward direction (i.e. the direction D4), the displayed channel of the television 32 is switched to the next channel by means of the G-Sensor 22. Similarly, if the user creates a gesture symbol by moving the touch pen 2 in the air along an upward direction (i.e. the direction D1), the output sound volume of the television 32 is corresponding increased (i.e. sound volume up). Similarly, if the user creates a gesture symbol by moving the touch pen 2 in the air along a downward direction (i.e. the direction D2), the output sound volume of the television 32 is corresponding decreased (i.e. sound volume down). Similarly, if the user creates a gesture symbol by rotating the touch pen 2 in the air along a counterclockwise direction (i.e. the direction D5), the television 32 is powered off. Similarly, if the user creates a gesture symbol by rotating the touch pen 2 in the air along a clockwise direction (i.e. the direction D6), the television 32 is powered on. It is noted that the corresponding tasks of the gesture symbols are not restricted to the above tasks. That is, the corresponding tasks may be varied according to the practical requirements.

Moreover, the user may press down the two push buttons 26 to select the first remote control mode of the touch pen 2 to be a character input mode or a gesture symbol mode. Consequently, the possibility of causing misjudgment by the second micro control unit 211 of the second wireless transmission module 21 will be minimized. For example, if the downward-movement gesture symbol in the direction D2 is erroneously recognized as the English letter “I”, the first control signal is error. The way of selecting the first remote control mode of the touch pen 2 to be the character input mode or the gesture symbol mode can minimize the possibility of generating the erroneous first control signal.

From the above descriptions, the user may use the touch pen 2 to input the numbers 0˜9 into the television 32. In addition, the user may move the touch pen 2 along a specified direction to have the television 32 implement the corresponding tasks. The tasks include the task of switching the displayed channel, the task of adjusting the sound volume and so on. Consequently, the touch pen 2 can replace the conventional remote controller in order to provide more convenience to the user.

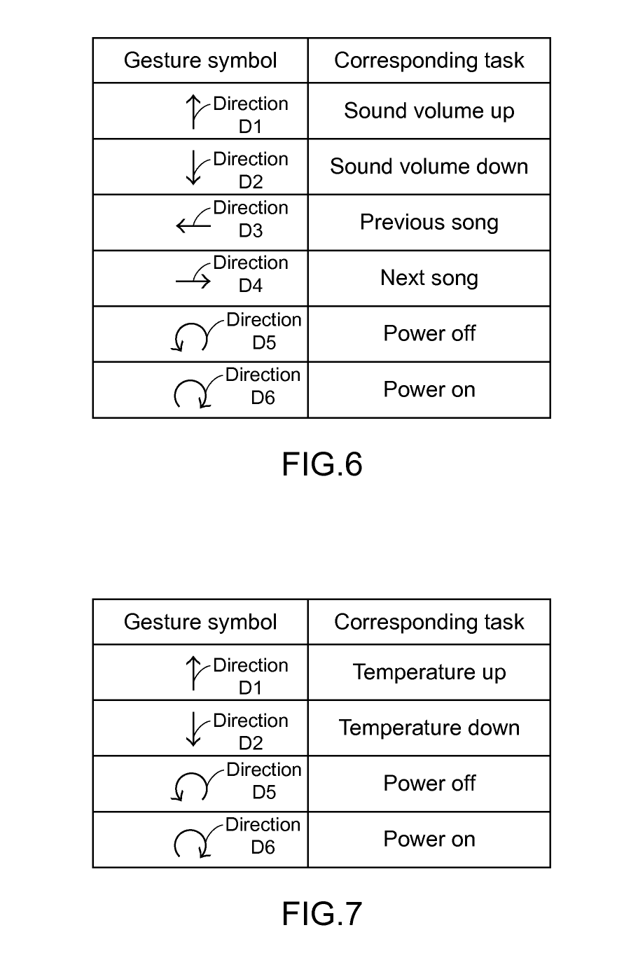

Hereinafter, an application example of the touch pen in a second remote control mode will be illustrated with reference to FIGS. 2, 3 and 6. FIG. 6 schematically illustrates the relationships between some symbol gestures and the corresponding tasks for the touch pen in a second remote control mode. In this embodiment, the electronic device 3 is a video output device. For example, the electronic device 3 is a wireless speaker or a wireless stereo device with a networking function. After the touch pen 2 is operated in the second remote control mode and paired with the video output device, the user may use the touch pen 2 to implement a gesture symbol input function so as to control the video output device. The principles of implementing the gesture symbol input function are similar to that of the first remote control mode, and are not redundantly described herein.

In comparison with the first remote control mode, the relationships between the symbol gestures and the corresponding tasks in the second remote control mode are distinguished. For example, as shown in FIG. 6, if the user creates a gesture symbol by moving the touch pen 2 in the air along the leftward direction (i.e. the direction D3), the G-Sensor 22 may sense that the angle change of the touch pen 2 is a leftward shift. In addition, the angle change of the touch pen 2 sensed by the G-Sensor 22 is transmitted to the second wireless transmission module 21. After the angle change of the touch pen 2 is analyzed by the second micro control unit 211 of the second wireless transmission module 21, the angle change of the touch pen 2 is converted into an instruction code corresponding to the leftward-movement gesture symbol. Then, a first control signal containing the instruction code corresponding to the leftward-movement gesture symbol is transmitted from the second wireless transmission module 21 to the first wireless transmission module 31 (see FIG. 3) of the video output device.

After the first control signal from the second wireless transmission module 21 is received by the first wireless transmission module 31, the first micro control unit 311 (see FIG. 3) judges that the first control signal contains the instruction code corresponding to the leftward-movement gesture symbol. Moreover, under control of the first micro control unit 311, the played song of the video output device is switched to the previous song. Consequently, the corresponding task is implemented.

Similarly, if the user creates a gesture symbol by moving the touch pen 2 in the air along the rightward direction (i.e. the direction D4), the played song of the video output device is switched to the next song by means of the G-Sensor 22. Similarly, if the user creates a gesture symbol by moving the touch pen 2 in the air along an upward direction (i.e. the direction D1), the output sound volume of the video output device is corresponding increased (i.e. sound volume up). Similarly, if the user creates a gesture symbol by moving the touch pen 2 in the air along a downward direction (i.e. the direction D2), the output sound volume of the video output device is corresponding decreased (i.e. sound volume down). Similarly, if the user creates a gesture symbol by rotating the touch pen 2 in the air along a counterclockwise direction (i.e. the direction D5), the video output device is powered off. Similarly, if the user creates a gesture symbol by rotating the touch pen 2 in the air along a clockwise direction (i.e. the direction D6), the video output device is powered on. It is noted that the corresponding tasks of the gesture symbols are not restricted to the above tasks. That is, the corresponding tasks may be varied according to the practical requirements.

Hereinafter, an application example of the touch pen in a third remote control mode will be illustrated with reference to FIGS. 2, 3 and 7. FIG. 7 schematically illustrates the relationships between some symbol gestures and the corresponding tasks for the touch pen in a third remote control mode. In this embodiment, the electronic device 3 is an intelligent appliance. For example, the electronic device 3 is a refrigerator with a networking function. After the touch pen 2 is operated in the third remote control mode and paired with the refrigerator, the user may use the touch pen 2 to implement a gesture symbol input function so as to control the refrigerator. The principles of implementing the gesture symbol input function are similar to that of the first remote control mode, and are not redundantly described herein.

In comparison with the first remote control mode, the relationships between the symbol gestures and the corresponding tasks in the third remote control mode are distinguished. For example, as shown in FIG. 7, if the user creates a gesture symbol by moving the touch pen 2 in the air along an upward direction (i.e. the direction D1), the output temperature of the refrigerator is corresponding increased (i.e. temperature up). Similarly, if the user creates a gesture symbol by moving the touch pen 2 in the air along a downward direction (i.e. the direction D2), the output temperature of the refrigerator is corresponding decreased (i.e. temperature down). Similarly, if the user creates a gesture symbol by rotating the touch pen 2 in the air along a counterclockwise direction (i.e. the direction D5), the refrigerator is powered off. Similarly, if the user creates a gesture symbol by rotating the touch pen 2 in the air along a clockwise direction (i.e. the direction D6), the refrigerator is powered on. It is noted that the corresponding tasks of the gesture symbols are not restricted to the above tasks. That is, the corresponding tasks may be varied according to the practical requirements.

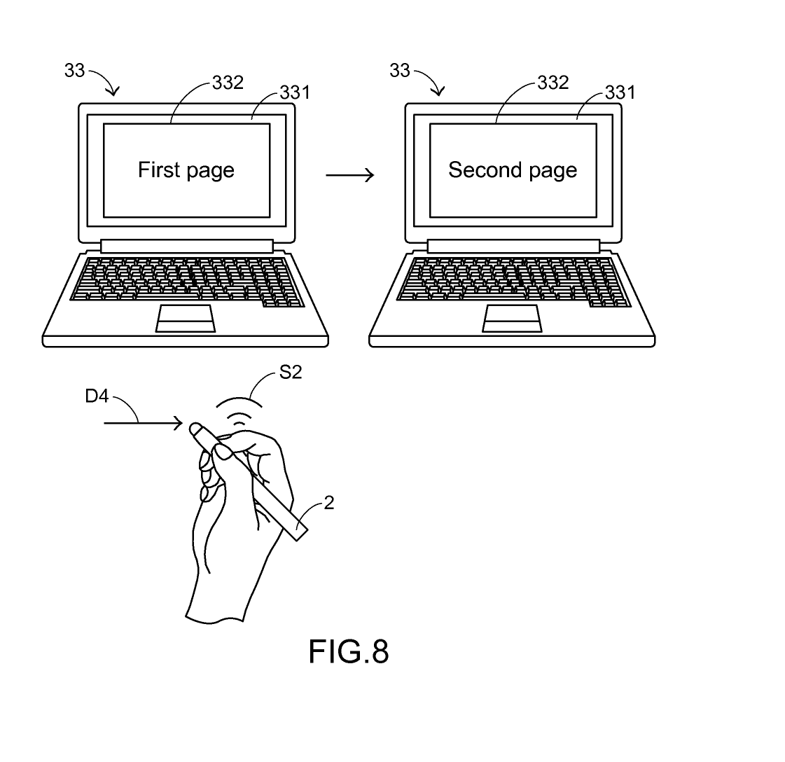

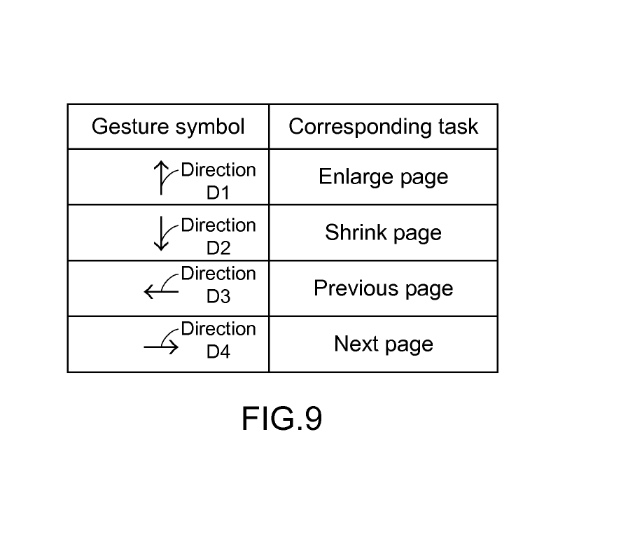

Hereinafter, an application example of the touch pen in a fourth remote control mode will be illustrated with reference to FIGS. 2, 3, 8 and 9. FIG. 8 schematically illustrates an application example of the touch pen in a fourth remote control mode according to the embodiment of the present invention. FIG. 9 schematically illustrates the relationships between some symbol gestures and the corresponding tasks for the application example of FIG. 8 in the fourth remote control mode. In this embodiment, the electronic device 3 is a mobile device or a computer with a display screen. As shown in FIG. 8, the electronic device 3 is a notebook computer 33. Similarly, after the touch pen 2 is operated in the fourth remote control mode and paired with the notebook computer 33, the user may use the touch pen 2 to implement a gesture symbol input function or a character input function so as to control the notebook computer 33. The principles of implementing the gesture symbol input function or the character input function are similar to that of the first remote control mode, and are not redundantly described herein.

In comparison with the first remote control mode, the relationships between the symbol gestures and the corresponding tasks in the fourth remote control mode are distinguished. Please refer to FIGS. 8 and 9. For example, if the user creates a gesture symbol by moving the touch pen 2 in the air along a rightward direction (i.e. the direction D4), the G-Sensor 22 may sense that the angle change of the touch pen 2 is a rightward shift. In addition, the angle change of the touch pen 2 sensed by the G-Sensor 22 is transmitted to the second wireless transmission module 21. After the angle change of the touch pen 2 is analyzed by the second micro control unit 211 of the second wireless transmission module 21, the angle change of the touch pen 2 is converted into an instruction code corresponding to the rightward-movement gesture symbol. Then, a first control signal S2 containing the instruction code corresponding to the rightward-movement gesture symbol is transmitted from the second wireless transmission module 21 to the first wireless transmission module 31 (see FIG. 3) of the notebook computer 33.

After the first control signal S2 from the second wireless transmission module 21 is received by the first wireless transmission module 31, the first micro control unit 311 (see FIG. 3) judges that the first control signal contains the instruction code corresponding to the rightward-movement gesture symbol. Moreover, under control of the first micro control unit 311, a presentation page 332 shown on the display screen 331 of the notebook computer 33 is switched from the first page to the second page. Consequently, the corresponding task is implemented.

Similarly, if the user creates a gesture symbol by moving the touch pen 2 in the air along the leftward direction (i.e. the direction D3), the presentation page 332 shown on the display screen 331 of the notebook computer 33 is switched from the second page to the first page. Consequently, a page switching function is achieved. Similarly, if the user creates a gesture symbol by moving the touch pen 2 in the air along the upward direction (i.e. the direction D1), the presentation page 332 shown on the display screen 331 of the notebook computer 33 is enlarged. Consequently, a page scaling function is achieved. Similarly, if the user creates a gesture symbol by moving the touch pen 2 in the air along the downward direction (i.e. the direction D2), the presentation page 332 shown on the display screen 331 of the notebook computer 33 is shrunken. Consequently, the page scaling function is achieved. It is noted that the corresponding tasks of the gesture symbols are not restricted to the above tasks. That is, the corresponding tasks may be varied according to the practical requirements.

Moreover, in the fourth remote control mode, the laser source 25 may be enabled to project a light beam onto the display screen 331 in order to provide an indicating function.

It is noted that the touch pen 2 may be operated in other remote control mode. For example, in a fifth remote control mode, the touch pen 2 can monitor the residual capacity of the electronic device 3. For example, the electronic device 3 is an intelligent appliance such as a refrigerator or a dehumidifier. After the touch pen 2 is operated in the fifth remote control mode and the process of pairing the first wireless transmission module 31 of the electronic device 3 with the second wireless transmission module 21 of the touch pen 2 is completed, a capacity monitor signal corresponding to the inner residual capacity of the electronic device 3 is transmitted from the first micro control unit 311 of the electronic device 3 to the second wireless transmission module 21. After the capacity monitor signal is received by the second wireless transmission module 21, the second micro control unit 211 controls the indication light source 29 to emit a corresponding indication light beam according to the inner residual capacity of the electronic device 3. The indication light beam may prompt the user. For example, if the residual capacity of the electronic device 3 is insufficient, the indication light beam is a red indication light beam, but is not limited thereto.

Moreover, the numbers and characters associated with the instruction codes corresponding to specified numbers and specified characters and the corresponding tasks associated with the instruction codes corresponding to specified gesture symbols in all remote control modes have been previously stored in the second micro control unit 211 of the touch pen 2. Moreover, the numbers and characters associated with the instruction codes corresponding to the specified numbers and the specified characters and the corresponding tasks associated with the instruction codes corresponding to the specified gesture symbols have also been previously stored in the first micro control unit 311 of the electronic device 3. Consequently, after the first control signal contains the instruction code corresponding to a specified number, a specified character or a specified gesture symbol is transmitted to the electronic device 3, the first micro control unit 311 of the electronic device 3 can automatically recognize the corresponding number or character to be displayed or implement the corresponding task.

As mentioned above, the touch pen 2 may be paired with various electronic devices 3. In this embodiment, the pairing identification codes corresponding to various electronic devices 3 are stored in the memory 34 of the touch pen 2. Consequently, when the touch pen 2 is switched to a different remote control mode to operate a different electronic device 3, it is not necessary to pair the touch pen 2 with the corresponding electronic device 3 again. That is, when the touch pen 2 is in any remote control mode, the touch pen 2 can be automatically in communication with the corresponding electronic device 3 without the need of performing the pairing process again.

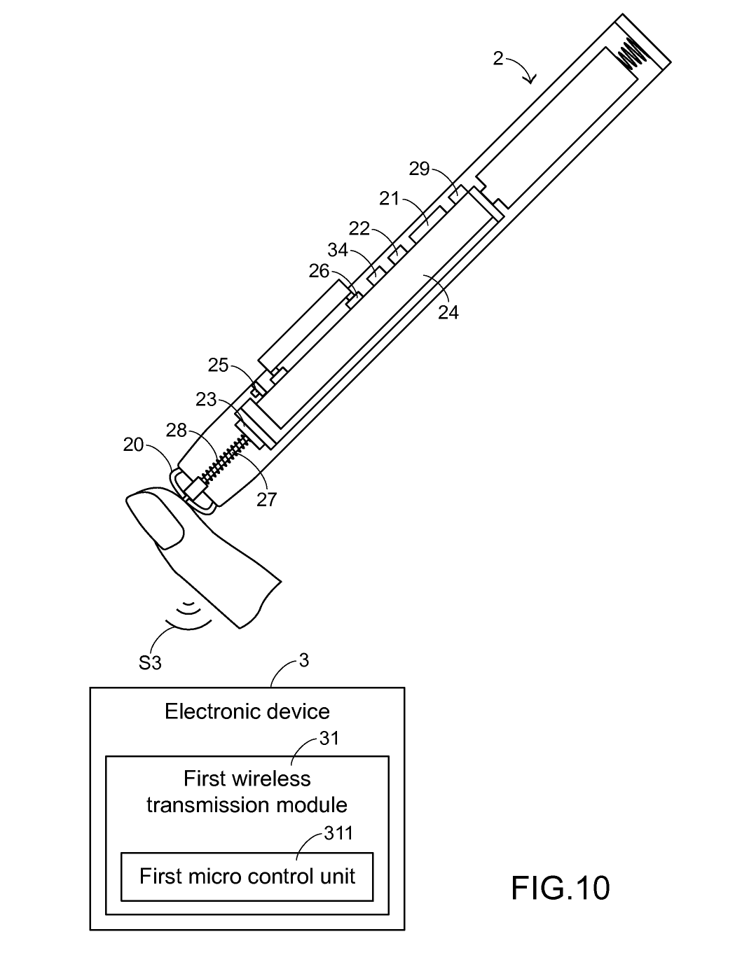

Please refer to FIGS. 2, 3 and 10. FIG. 10 schematically illustrates the use of the touch pen to control the electronic device by issuing a second control signal. As shown in FIG. 2, the touch pen 2 further comprises a fixing post 27 and an elastic element 28. The fixing post 27 is connected with the pressure sensor 23. The elastic element 28 is sheathed around the fixing post 27 for returning the fixing post 27 to its original position. When a pressure is exerted on the pen tip 20, the fixing post 27 is pushed by the pen tip 20 so as to press the pressure sensor 23. Consequently, a resistance value of the pressure sensor 23 is subject to a change. Due to the change of the resistance value, the pressure sensor 23 can detect the pressure exerted on the pen tip 20 and the magnitude of the pressure.

In each of the above remote control modes, if the pen tip 20 is pressed by the user's finger or other object and a pressure exerted on the pen tip 20 is detected by the pressure sensor 23, the second micro control unit 211 may allow the second wireless transmission module 21 to issue a corresponding second control signal S3 to the first wireless transmission module 31. After the second control signal S3 is received by the electronic device 3, the use may set the corresponding function of the electronic device 3 that is enabled by pressing down a single push button 26 in a corresponding remote control mode. For example, the user may press down a single push button 26 to enable a mute function in the first remote control mode; the user may press down a single push button 26 to enable the laser source 25 in the fourth remote control mode, and the user may press down another single push button 26 to start or stop playing the browser window 322 in the fourth remote control mode. It is noted that the function to be enabled by pressing down a single push button 26 is not restricted. Similarly, after the second control signal S3 is received by the electronic device 3, the use may set the corresponding task of the electronic device 3 that is implemented according to a gesture symbol in a corresponding remote control mode. However, for allowing the user to set the corresponding functions associated with the two push buttons or the corresponding tasks associated with the gesture symbols, a corresponding application program or driver should be previously installed in the electronic device 3. Moreover, the corresponding functions associated with the two push buttons or the corresponding tasks associated with the gesture symbols may be stored in the memory 34 of the touch pen 2.

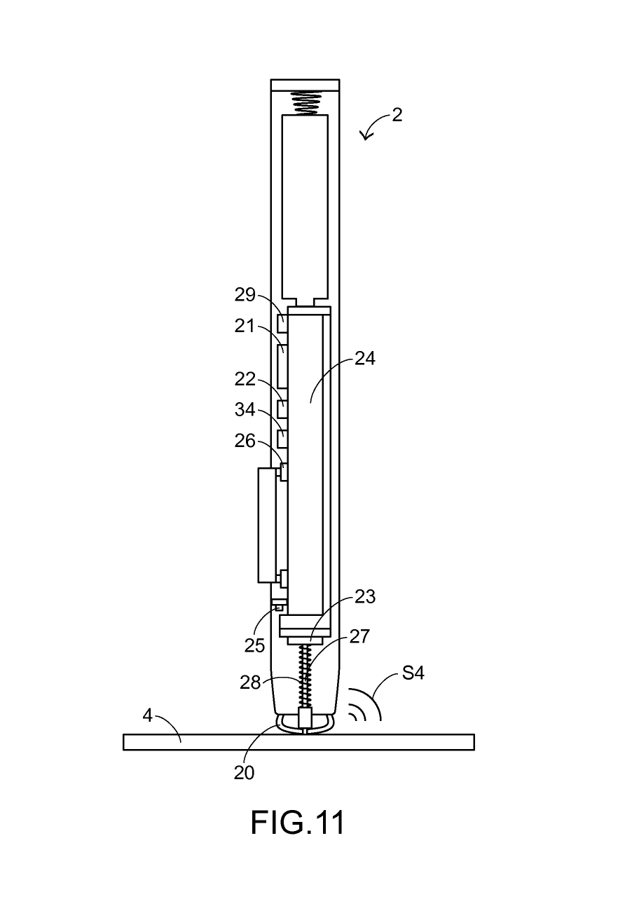

FIG. 11 schematically illustrates the use of the touch pen to control the capacitive touch screen by issuing a second control signal. When the touch pen 2 is in the touch mode, the touch pen 2 may be used to control a capacitive touch screen 4. For example, the touch pen 2 may be moved on a surface of the capacitive touch screen to perform a drawing task. At the same time, if the capacitive touch screen 4 is pressed by the pen tip 20 and the fixing post 27 is pushed by the pen tip 20 so as to press the pressure sensor 23, the pressure sensor 23 can detect the pressure exerted on the pen tip 20 and the magnitude of the pressure. Consequently, the pressure sensor 23 issues the corresponding second control signal S4.

Moreover, a corresponding application program may be installed in a device with the capacitive touch screen 4 (e.g. a smart phone or a tablet computer). When the second control signal S4 from the touch pen 2 is received by the device with the capacitive touch screen 4, a size or a color of a display object corresponding to a touch region of the touch pen 20 is changed by the device with the capacitive touch screen 4 according to the second control signal S4. For example, if the display object corresponding to a touch region of the touch pen 20 is a line, the line is thicker according to the second control signal S4 corresponding to the higher magnitude of the pressure. Whereas, the line is thinner according to the second control signal S4 corresponding to the lower magnitude of the pressure. On the other hand, if the display object corresponding to a touch region of the touch pen 20 is a geometric pattern, the size of the geometric pattern is larger according to the second control signal S4 corresponding to the higher magnitude of the pressure. Whereas, the size of the geometric pattern is smaller according to the second control signal S4 corresponding to the lower magnitude of the pressure. The above examples are presented herein for purpose of illustration and description only. It is noted that the profile of the display object corresponding to a touch region of the touch pen 20 is not restricted.

From the above descriptions, the touch pen 2 is capable of controlling the capacitive touch screen 4 and the electronic device 3 by means of the second wireless transmission module 21, the G-Sensor 22 and the pressure sensor 23. In other words, the touch pen 2 is a multi-function touch pen that can overcome the drawbacks of the conventional technology.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A touch pen for controlling a capacitive touch screen and an electronic device, the electronic device comprising a first wireless transmission module, the touch pen comprising:
a pen tip interacted with the capacitive touch screen;
a second wireless transmission module in communication with the first wireless transmission module;
a G-sensor sensing an angle change of the touch pen; and
a pressure sensor sensing a pressure that is exerted on the pen tip,
wherein according to the angle change of the touch pen sensed by the G-sensor, a corresponding first control signal is transmitted from the second wireless transmission module to the first wireless transmission module so as to control the electronic device, and according to the pressure exerted on the pen tip and sensed by the pressure sensor, a corresponding second control signal is transmitted from the second wireless transmission module to the first wireless transmission module or the capacitive touch screen so as to control the electronic device or the capacitive touch screen.

2. The touch pen according to claim 1, wherein a capacity monitor signal corresponding to a residual capacity of the electronic device is further transmitted from the first wireless transmission module to the second wireless transmission module.

3. The touch pen according to claim 2, wherein the touch pen further comprises an indication light source, wherein the indication light source emits a corresponding light beam according to the capacity monitor signal.

4. The touch pen according to claim 1, wherein the first wireless transmission module comprises a first micro control unit, and the second wireless transmission module comprises a second micro control unit.

5. The touch pen according to claim 1, wherein the angle change is related with at least one character, and the at least one character is displayed on the electronic device according to the first control signal.

6. The touch pen according to claim 1, wherein the angle change is related with at least one gesture symbol, and a corresponding task associated with the at least one gesture symbol is implemented according to the first control signal.

7. The touch pen according to claim 6, wherein the corresponding task includes a task of adjusting an output sound volume, a task of switching a channel, a task of switching a page, a task of scaling a page, a task of switching a song, a task of adjusting a temperature, a task of powering on the electronic device or a task of powering off the electronic device.

8. The touch pen according to claim 6, wherein the corresponding task associated with the at least one gesture symbol is changed according to the second control signal.

9. The touch pen according to claim 1, wherein a size or a color of a display object corresponding to a touch region of the touch pen is changed by the capacitive touch screen and according to the second control signal.

10. The touch pen according to claim 1, wherein the touch pen further comprises at least one push button selectively pressed to switch an operational mode of the touch pen among a plurality of remote control modes and a touch mode, and then selectively pressed to trigger a function of the electronic device after the second control signal is transmitted from the second wireless transmission module to the first wireless transmission module, wherein the function corresponding to the at least one push button varies with the remote control modes.

11. The touch pen according to claim 1, wherein the electronic device is an intelligent appliance, a video output device, a mobile device or a computer.

12. The touch pen according to claim 11, wherein the intelligent appliance is a television, an air conditioner, a refrigerator or a dehumidifier, or the video output device is a wireless speaker or a wireless stereo device.

13. The touch pen according to claim 1, wherein the touch pen further comprises a laser source.

14. The touch pen according to claim 13, wherein the pen tip further comprises a perforation, wherein a light beam emitted by the laser source passes through the perforation.

15. The touch pen according to claim 1, wherein the touch pen further comprises at least one push button, wherein when the at least one push button is triggered, the touch pen is operated in a remote control mode or a touch mode, wherein when the touch pen is in the touch mode, the G-sensor is disabled.

16. The touch pen according to claim 1, wherein the touch pen further comprises a memory, wherein a pairing identification code corresponding to the electronic device is stored in the memory.

17. The touch pen according to claim 1, wherein the touch pen further comprises:
a fixing post connected with the pen tip and arranged between the pen tip and the pressure sensor, wherein the pressure sensor is pressed by the fixing post; and
an elastic element sheathed around the fixing post, wherein the fixing post is returned to an original position by the elastic element.

18. The touch pen according to claim 1, wherein the pen tip is made of a conductive rubbery material, a metallic material or a conductive plastic material, wherein the touch pen is a passive touch pen or an active touch pen.
